(19) United States
(12) Patent Application Publication
(10) Pub. No.: US 2021/0264137 A1
(43) Pub. Date: Aug. 26, 2021

(54) COMBINED PERSON DETECTION AND FACE RECOGNITION FOR PHYSICAL ACCESS CONTROL

(71) Applicant: NEC Laboratories America, Inc., Princeton, NJ (US)

(72) Inventors: Kunal Rao, Monroe, NJ (US); Yi Yang, Princeton, NJ (US); Giuseppe Coviello, Princeton, NJ (US); Srimat Chakradhar, Manalapan, NJ (US)

(21) Appl. No.: 17/178,444

(22) Filed: Feb. 18, 2021

Related U.S. Application Data
(60) Provisional application No. 62/979,499, filed on Feb. 21, 2020.

(51) Int. Cl. G06K 9/00; G06T 7/20; G08B 13/196

(52) U.S. Cl. CPC G06K 9/00295; G06T 7/20; G06T 2207/30201; G06T 2207/10016; G06T 2207/30232; G08B 13/19608

(57) ABSTRACT

Methods and systems for managing access include detecting a person within a region of interest in a video stream. It is determined that a clear image of the person's face is not available within the region of interest. Tracking information of the person is matched to historical face tracking information for the person in a previously captured frame. The person's face from the previously captured video frame is matched to an authentication list, responsive to detecting the person within the region of interest, to determine that the detected person is unauthorized for access. A response to the determination that the detected person is unauthorized for access is performed.

### RELATED APPLICATION INFORMATION

This application claims priority to U.S. Application No. 62/979,499, filed on Feb. 21, 2020, incorporated herein by reference in its entirety.

### BACKGROUND

### Technical Field

The present invention relates to authentication and, more particularly, to the use of person detection and face recognition in physical access control.

### Description of the Related Art

Performing authentication of individuals in a large facility is challenging, particularly in contexts like stadiums, where there are areas where the general public is permitted and areas where only authorized personnel are permitted. Authentication may be needed in areas where network connectivity is limited or intermittent, and large numbers of people may need to be checked for access in real time.

### SUMMARY

A method for managing access includes detecting a person within a region of interest in a video stream. It is determined that a clear image of the person's face is not available within the region of interest. Tracking information of the person is matched to historical face tracking information for the person in a previously captured frame. The person's face from the previously captured video frame is matched to an authentication list, responsive to detecting the person within the region of interest, to determine that the detected person is unauthorized for access. A response to the determination that the detected person is unauthorized for access is performed.

A system for managing access includes a hardware processor and a memory that stores a computer program product. When the computer program product is executed by the hardware processor, it causes the hardware processor to detect a person within a region of interest in a video stream. It is determined that a clear image of the person's face is not available within the region of interest. Tracking information of the person is matched to historical face tracking information for the person in a previously captured frame. The person's face from the previously captured video frame is matched to an authentication list, responsive to detecting the person within the region of interest, to determine that the detected person is unauthorized for access. A response to the determination that the detected person is unauthorized for access is performed.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an exemplary environment, where an access management system monitors individuals and uses facial recognition to identify when unauthorized users enter a controlled area, in accordance with an embodiment of the present invention; FIG. 2 is a block diagram of a distributed access management system, which uses multiple worker systems to handle access management, in accordance with an embodiment of the present invention;

FIG. 3 is a block diagram of a master system that controls a distributed access management system, in accordance with an embodiment of the present invention;

FIG. 4 is a block diagram of a worker system in a distributed access management system, in accordance with an embodiment of the present invention;

FIG. 5 is a block/flow diagram of a method for managing access to a controlled area using merged facial recognition and person detection tracking information, in accordance with an embodiment of the present invention;

FIG. 6 is a block/flow diagram for ensuring that worker systems have up-to-date authentication information, but can continue to operate when updates are not possible, in accordance with an embodiment of the present invention; and

FIG. 7 is a block/flow diagram of a method for managing access based on facial recognition, in accordance with an embodiment of the present invention.

### DETAILED DESCRIPTION OF PREFERRED EMBODIMENTS

Embodiments of the present invention provide distributed streaming video analytics for real-time authentication of large numbers of people. For example, the present embodiments can access video feeds from cameras and can identify the presence of people. Using face recognition in combination with person detection, authentication can be performed for individuals who are moving through a controlled access point, such as a door or gate. The present embodiments can include lists of individuals, both authorized and specifically non-authorized, and can provide alerts as people on such lists are recognized.

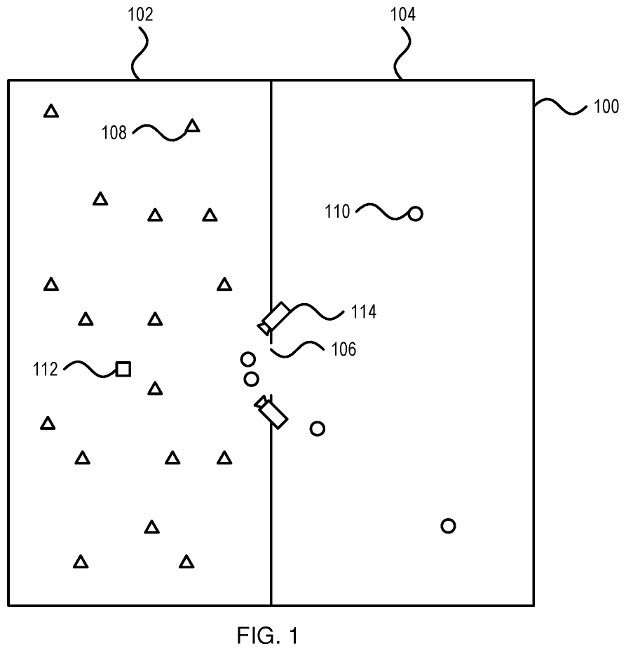

Referring now to FIG. 1, an exemplary monitored environment 100 is shown. The environment 100 shows two regions, including an uncontrolled region 102 and a controlled region 104. It should be understood that this simplified environment is shown solely for the sake of illustration, and that realistic environments may have many such regions, with differing levels of access control. For example, there may be multiple distinct controlled regions 104, each having different sets of authorized personnel with access to them. In some embodiments, regions may overlap.

A boundary is shown between the uncontrolled region 102 and the controlled region 104. The boundary can be any appropriate physical or virtual boundary. Examples of physical boundaries include walls and rope—anything that establishes a physical barrier to passage from one region to the other. Examples of virtual boundaries include a painted line and a designation within a map of the environment 100. Virtual boundaries do not establish a physical barrier to movement, but can nonetheless be used to identify regions with differing levels of control. A gate 106 is shown as a passageway through the boundary, where individuals are permitted to pass between the uncontrolled region 102 and the controlled region 104.

A number of individuals are shown, including unauthorized individuals 108, shown as triangles, and authorized individuals 110, shown as circles. Also shown is a banned individual 112, shown as a square. The unauthorized individuals 108 are permitted access to the uncontrolled region 102, but not to the controlled region 104. The authorized individuals are permitted access to both the uncontrolled region 102 and the controlled region 104. The banned individual 112 is not permitted access to either region.

The environment 100 is monitored by a number of video cameras 114. Although this embodiment shows the cameras 114 being positioned at the gate 106, it should be understood that such cameras can be positioned anywhere within the uncontrolled region 102 and the controlled region 104. The video cameras 114 capture live streaming video of the individuals in the environment, and particularly of those who attempt to enter the controlled region 104. Additional monitoring devices (not shown) may be used as well, for example to capture radio-frequency identification (RFID) information from badges that are worn by authorized individuals 108.

Referring now to FIG. 2, a diagram of a distributed authentication system is shown. A single master system 202 communicates with a number of worker systems 204. The master system 202 handles authentication-list management, alert management, and can optionally also handle third-party message management. Worker systems 204 are assigned to respective regions in the environment 100, or in some cases to particular gates 106, and locally handle authentication and authentication-list checking. Depending on the computational resources of the worker systems 204, one or more video streams can be handled at each worker system 204. Multiple worker system 204 can be added to a single master system 202 to dynamically scale and include more locations for authentication, without affecting existing live operation.

In general, for applications where there need only be a single instance across a site, such functions are implemented by the master system 202. In contrast, video collection, person detection, face recognition, and other related tasks may be performed by the individual worker systems 204.

In some embodiments, the worker systems 204 can be connected to the master system 202 by any appropriate network, for example a local area network. In other embodiments, the worker systems 204 can be connected to the master system 202 and to one another via a mesh network, where each system communicates wirelessly with one or more neighboring systems to create a communication chain from each worker system 204 to the master system 202. In some cases, where communication with the master system 202 is unreliable or intermittent, the worker systems 204 can communicate with one another to obtain authentication-lists. In some embodiments, the worker systems 204 can communicate with one another via a distinct network as compared to their communications with the master system. For example, worker systems 204 may be connected to one another via a wired local area network, whereas the master system 202 may be available through a wireless network, such as a cell network.

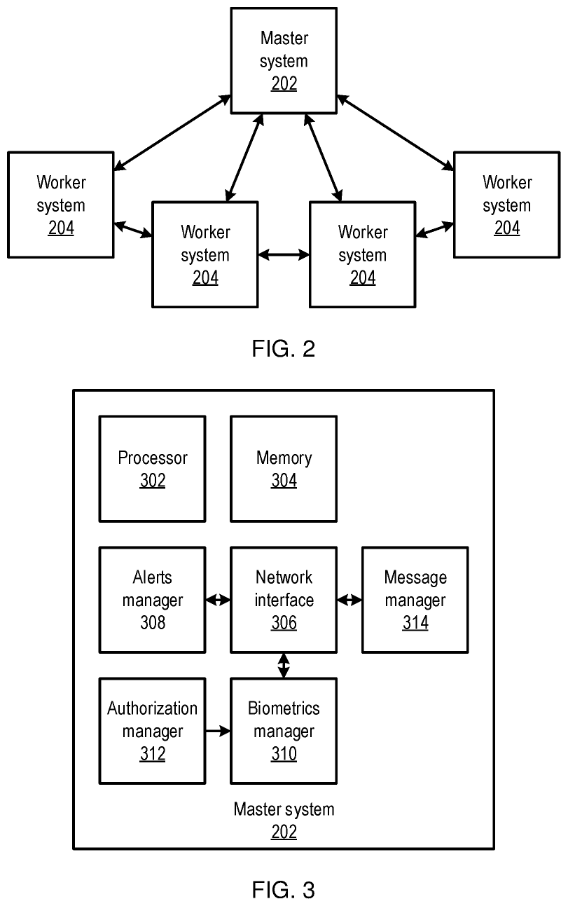

Referring now to FIG. 3, detail of an exemplary master system 202 is shown. The master system 202 includes a hardware processor 302 and a memory 304. A network interface 306 provides communications between the master system 202 and the worker systems 204. The network interface 306 can also provide communications with other systems, such as corporate databases that include credential information, as well as providing access to third-party information, including data streams, authentication-list information, and credential information. The network interface 306 can communicate using any appropriate wired or wireless communications medium and protocol.

An alerts manager 308 can, for example, use the network interface 306 to receive communications from the worker systems 202 relating to individual authentication results. For example, when a worker system 202 determines that an unauthorized individual 106 has entered a controlled region 104, the alert manager 308 can issue an alert to a supervisor or to security personnel. The alert manager 308 can also trigger one or more actions, such as sounding an alarm or automatically locking access to sensitive locations and material. The alerts manager 308 can furthermore store alerts from the worker system 202, including information relating to any local overrides at the worker system 202.

A biometrics manager 310 can manage authentication-lists, including lists of authorized individuals and banned individuals, and can furthermore maintain information relating to the people in those lists. For example, biometrics manager 310 can maintain a database for each individual in each list, to store details that may include the individual's access privileges, etc. The biometrics manager 310 can provide an interface that allows users to add, update, and remove individuals from authentication-lists, to turn on and off authentication for particular authentication-lists, to add, remove, and update authentication-lists themselves, to search for individuals using their names or images, and to merge records/entries when a particular individual has multiple such records.

The biometrics manager 310 can communicate with an authorization manager 312. The authorization manager 312 can interface with a corporate database, for example via local storage or via the network interface 306, to retrieve authorization information for individuals, such as an image of the individual and the individual's access privileges. The authorization manager 312 can, in some embodiments, be integrated with the biometrics manager 310, or can be implemented separately.

A message manager 314 receives third-party information through the network interface 306. For example, message manager 314 can provide an interface to third-party applications that makes it possible to perform authentication and issue alerts based on information that is collected by a third-party devices.

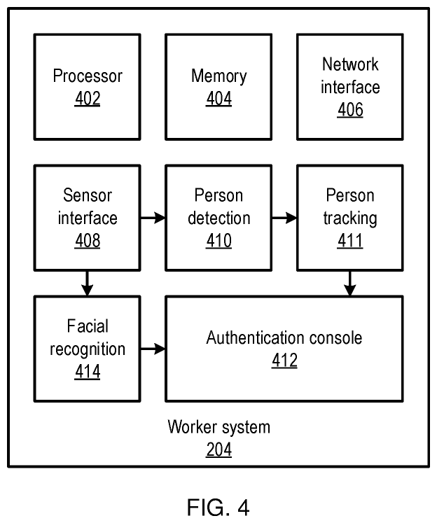

Referring now to FIG. 4, detail of an exemplary worker system 204 is shown. The worker system 204 includes a hardware processor 402 and a memory 404. A network interface 406 provides communications between the worker system 204 and the master system 202. The network interface 406 can also provide communications with one or more network-enabled data-gathering devices, such as networked security cameras. The network interface 406 can communicate using any appropriate wired or wireless communications medium and protocol.

A sensor interface 408 gathers information from one or more data-gathering devices. In some embodiments, these devices can connect directly to the sensor interface 408 to provide, e.g., a video stream. In other embodiments, the data-gathering devices can be network-enabled, in which case the sensor interface 408 collects the information via the network interface 406. It should be understood that the sensor interface 408 can support connections to various types, makes, and models, of data-gathering devices, and may in practice represent multiple physical or logical components, each configured to interface with a particular kind of data-gathering device. In embodiments where the sensor interface 408 receives information from one or more video cameras, the sensor interface 408 receives the camera feed(s) and outputs video frames.

Facial recognition 414 is performed on video frames from the sensor interface 408. Facial detection 414 may be performed using, e.g., a neural network-based machine learning system that recognizes the presence of a face within a video frame and that provides a location within the video frame, for example as a bounding box. Detected faces in the frames are provided to authentication console 412, along with their locations within the frames. As the detected faces move from frame to frame, tracking information may be provided. Face recognition 410 may include filtering a region of interest within a received video frame, discarding unwanted portions of the frame, and generating a transformed frame that includes only the region of interest (e.g., a region with a face in it). Face detection 410 can furthermore perform face detection on the transformed frame either serially, or in parallel. In some embodiments, for example when processing video frames that include multiple regions, the different regions of interest can be processed serially, or in parallel, to identify faces.

Person detection 410 is performed on video frames from the sensor interface 408. Person detection 410 may be performed using, e.g., a neural network-based machine learning system that recognizes the presence of a person-shaped object within a video frame and that provides a location within the video frame, for example as a bounding box. The locations of detected people within the frames are provided to the person tracking 411. Face detections in each frame are assigned to track information from preceding frames. Person tracking 411 tracks the occurrence of particular faces across sequences of images, for use by authentication console 412.

Authentication console 412 retrieves detected faces from facial recognition 414 and stores them for a predetermined time window. In face matching, authentication console 412 determines whether the detected face is associated with an authorized person, for example, someone who is authorized to enter a controlled area 104. In one example, facial recognition 414 may recognize the face of an authorized individual 108 approaching a gate 106. The authentication console 412 may control access to the gate 106, and may trigger an alert if an unauthorized individual is found to be passing through the gate 106.

Authentication console 412 furthermore connect to the master system 202, and in particular biometrics manager 310, to obtain authentication-list information, including the above-mentioned details of the individuals in the authentication-lists. Because the network connection between the worker systems 204 and the master system 202 can be unreliable or intermittent, authentication console 412 can keep track of how recently the authentication-list was updated and can provide a local alert when the authentication-list is significantly out of date. The authentication console 412 can furthermore communicate to the alerts manager 308 information regarding any denial or grant of access, including the reasons therefore, to trigger an appropriate alert. This information can be stored for audit purposes. If access was granted, then the stored information can include their identity and the time of access. If access was denied, then the stored information can include their identity, the time of denial, and the reason for denial. In the event that the determination of the authentication console 412 is overridden by a supervisor, then information can also be stored regarding who performed the override, what the original result and the override result were, and the time.

Facial recognition 414 can store detected faces in memory 404. In some embodiments, the detected faces can be removed from memory 404 after the expiration of a predetermined time window. The authentication console 412 can similarly keep a face matching request for a predetermined time period. If no face is matched in that time, the authentication console 412 can delete the face matching request.

The authentication console 412 may receive information from the sensor interface 408, for example collecting video frames. The authentication console 412 provides a user interface for security personnel, making it possible for such personnel to view the camera feeds, to view authentication results (along with reasons for denial), to view schedule information for recognized individuals, to view the network connection status to the master system 202, to view the database freshness (e.g., the amount of time since the database was last updated), to view and adjust the position of particular cameras/sensors, and to override authentication determinations.

The authentication console 412 can also manage notifications. These notifications can include instructions from the master system 202 to add, update, or remove particular authentication-lists, instructions which the authentication console 412 can perform responsive to receipt of the notifications. The notifications can also include local notifications, for example pertaining to whether the authentication-lists are freshly synchronized to the authentication-lists on the master system 202.

The memory 404 may store a list of authorized persons. The list may further include a list of persons who are specifically barred entry. The authentication console 412 may use this list to determine whether individuals who have identified within video frames are permitted entry. The worker 204 may dynamically update this list, for example periodically, upon detection of an unrecognized person, upon any authentication request, or according to any other appropriate stimulus.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

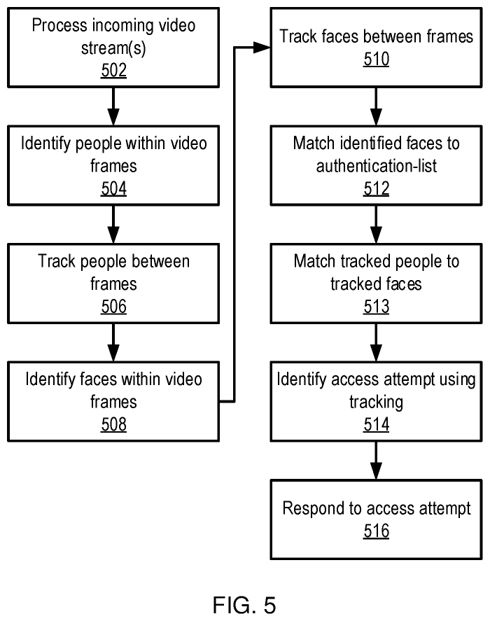

Referring now to FIG. 5, a method for managing access to a controlled area 104 is shown. Block 502 processes one or more incoming video streams, for example from cameras 114. This processing may be performed by one or more worker systems 204, each processing a respective set of video streams. In some cases, each video stream may be handled by a single worker system 204, but some video streams may be processed by multiple systems.

Block 504 identifies people within the video frames, for example using person detection 410. Person identification can be performed in parallel, for example with multiple frames of video being considered at once. As noted above, a machine learning system can be used to locate one or more person-shaped objects within the frames, block 506 then tracks the people across multiple frames using, e.g., person tracking 411. The tracking information provides continuity between frames, identifying the path that a person takes through a camera's visual field. A track may include an identification of multiple frames, with a same person being identified in each, showing the person's movement through the visual field of a camera 114.

In more detail, all detected persons within a video frame may be matched with previously detected persons in previous frames, for example by identifying overlaps in the bounding boxes of detected person-shaped objects from one frame to the next. If the overlap area between the currently detected person and the previously detected person is greater than a pre-defined threshold, then the location match may be determined to be successful. If there is a successful location match, then the person-shaped object in the current frame is given a same person tracking identifier as the matched object. If not, then a new person tracking identifier may be assigned. Thus, the tracking information may include a set of locations within a set of video frames that as assigned a same person tracking identifier.

Block 508 identifies faces within the video frames, for example using facial recognition 508. Block 510 then tracks faces across multiple frames. The tracking information provides continuity between frames, for example making easier to identify a face that is partially occluded in one frame, but exposed in another. In more detail, all detected faces within a video frame may be matched with previously detected faces in previous frames, for example by identifying overlaps in the bounding boxes of detected faces from one frame to the next. If the overlap area between the currently detected face and the previously detected face is greater than a pre-defined threshold, then the location match may be determined to be successful. If there is a successful location match, then the face in the current frame is given a same face tracking identifier as the matched face. If not, then a new face tracking identifier may be assigned. Thus, the tracking information may include a set of locations within a set of video frames that as assigned a same face tracking identifier. Additionally, face matching between face images at different points in time from the video stream may be used to match tracking identifiers, for example if a person's face is visible at different times.

Block 512 matches the identified faces to an authentication-list. This matching may associate the face with a profile, for example identifying a set of access privileges. The matching may also result in a determination that the user is not authorized for access, or is explicitly banned. This matching may be performed in parallel, for example having multiple tasks, each task matching each face to a different portion of the authentication-list.

As a person moves through the uncontrolled region 103, they may be tracked using both person detection and face detection. From time to time, there may be a break in tracking of one or the other type of detection, for example when the person's face is occluded by clothing or when the person walks behind an object. In particular, as the person approaches the gate 106, a hat or face covering may prevent the cameras 114 from obtaining a clear view of the person's face, making it difficult to identify the person at the point of entry.

However, block 513 matches the tracking information for the person and tracking information for the face. For example, the location of the person can be traced backwards in time until it coincides with tracking information for a clear face picture. This can be accomplished by matching locations and time information for person detection to locations and time information for face detection. This match can be made by identifying a bounding box for the face in each frame, and a bounding box for the person detection in each frame. When these bounding boxes overlap with one another within a frame, then a match can be identified.

The tracking information in block 513 can thereby be used to merge different tracks. For example, a person's face may come into and out of view multiple times, with person detection providing continuity across sequences of video. These multiple different tracks can be merged into a single tracking identification. Multiple partial views of a person's face can similarly be merged to provide a complete picture of the person's face for recognition.

Block 514 identifies an attempt to access the controlled area 104 based on the person and face tracking information, for example using the authentication console 412. This determination may be made when a person moves into a particular area of the visual field of a camera 114, for example indicating that the person is standing in front of a gate 106. If the person's face is not immediately visible, then block 514 can the matched tracking information of block 513 to identify a clearer picture of the person's face for facial recognition.

Block 516 responds to the attempted access. In some cases, this may include automatically locking or unlocking the gate 106, responsive to whether the person is authorized. Block 516 may further make use of associated information, to determine whether the person has access to the controlled area 104 at a particular time. If a person is detected in block 504, but an associated face is not recognized in block 512 or block 513, or no face is detected at all in block 508, then access may be denied.

In some cases, block 516 may not bar entry to unauthorized people, but may instead issue an alert. For example, security personnel may be alerted to the presence of an unauthorized person, and may be dispatched to find them. To decrease a number of false alerts, the response of block 516 may be delayed, past the time of entry, to allow the cameras 114 additional time to monitor the person and to identify a face. For example, if a person is wearing a hood as they approach an exterior door, the response may be delayed to allow the person to take their hood down inside, thereby providing a clear view of their face.

The severity of the response may be adjusted in accordance with the authorization level of the person. In the event that a person enters who does not show their face clearly, or who is not present in a facial recognition database, then the alert may have a relatively low degree of urgency, for example by summoning security personnel. If a person enters who is recognized as being someone who is specifically barred, then the alert may have a relatively high degree of urgency, for example by triggering a visual and/or auditory alarm.

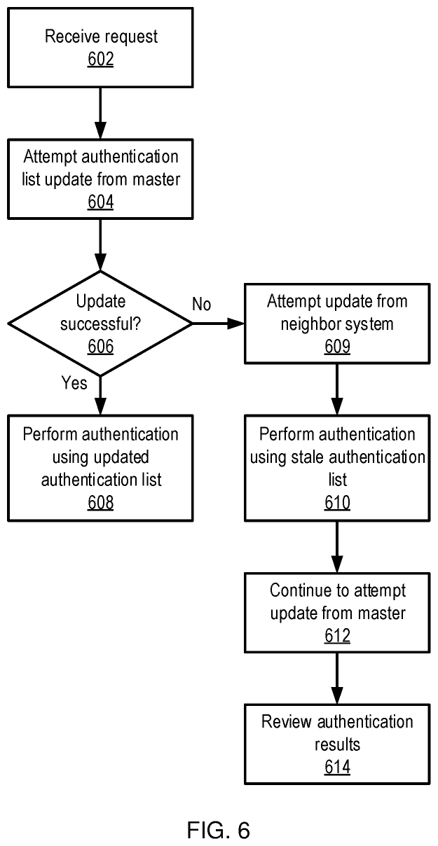

Referring now to FIG. 6, a method for obtaining updated authentication-lists is shown. Block 602 receives an authentication request for an individual at a worker system 204, for example as the individual enters a region of interest. The worker system 204 attempts to obtain the latest authentication-list information from the master system 202 by, for example, communicating over a wireless network, and block 606 checks whether the update was successful. Blocks 604 and 606 can further determine that no change has been made to the authentication-list since it was last downloaded, which can be treated as a successful update. If the update was successful, then the worker system 204 performs authentication in block 608 using the updated authentication-list. In some embodiments, updates to the authentication-list can be downloaded periodically, in addition to being prompted by an authentication request.

In some embodiments authentication-lists can be downloaded in batches. For example, if there are multiple different authentication-lists, then updates to all of the authentication-lists can be transmitted to the worker system 202 at the same time, thereby reducing the number of times that the worker system 202 has to communicate with the master system 204, and improving the overall freshness of the stored authentication-lists in the event that the connection is lost. The number of authentication-lists, and number of entries per authentication-list, that are updated in a single batch can be tuned to reflect the reliability of the network, so that a larger batch transfer is less likely to be interrupted.

If the update was not successful, the worker system 204 can, in some embodiments, attempt to obtain an updated authentication-list from a neighboring worker system. For example, if the master system 202 is down, or is not accessible due to a network fault, the worker systems 204 can share information to identify a most recent version of the authentication-list. Using the most recent available authentication-list, whether from a previously stored local version or a version at a neighboring system, block 610 performs authentication and allows or denies access to the individual. The authentication console 412 provides an alert at the worker system 204 to indicate that a stale authentication-list was used, so that a human operator can provide additional review if needed.

In some embodiments, block 610 can check to determine how old the most recent available authentication-list is. In the event that the most recent available authentication-list is older than a threshold value, then some embodiments can deny all authentication requests, until the authentication-list can be updated.

Block 612 continues to attempt updates from the master system 202. When a connection to the master system 202 is reestablished, an up-to-date authentication-list is downloaded. Block 614 can then review earlier authentication requests and can flag any denials or acceptances that were issued in error. For example, if an individual was allowed entry to a secured area 104 due to an out of date authentication-list, where the individual's access privileges had been removed, then the authentication console 412 can provide an alert.

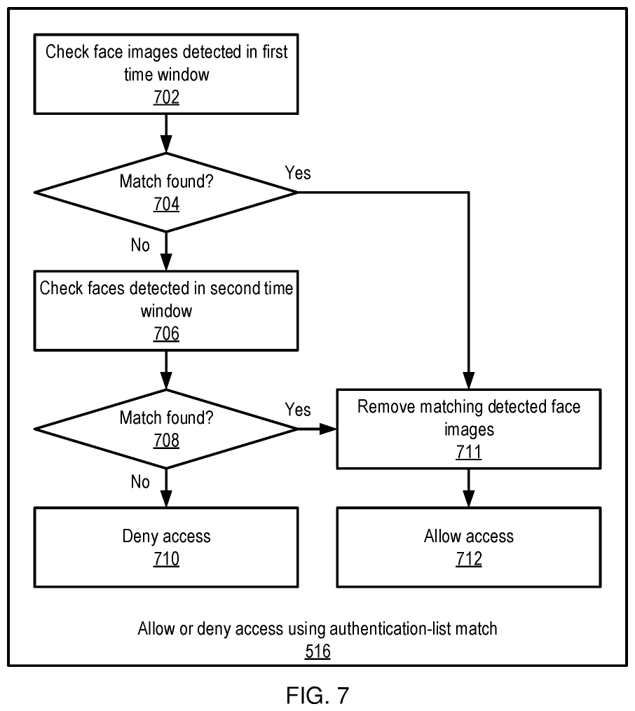

Referring now to FIG. 7, additional detail is shown on access management in step 516. As noted above, face matching can operate within defined time windows. When an authentication request is received, for example by a detected person entering a region of interest in a camera's visual feed, all faces detected in the region of interest during a first time window (e.g., between 10 and 30 seconds) preceding the authentication request are matched by block 702 to one or more mapped and stored images of the user. If a match is found by block 704, matching face images are deleted in block 711 and operation proceeds at block 712. If not, the authentication attempt can be repeated, for example every second, with the subsequently detected faces for a second time window (e.g., between 1 and 5 seconds) following the authentication request in block 706. If no match has been found by block 708 after the expiration of the second time window, the authentication request can be denied by block 710. The lengths of the time windows can vary, depending on the operational environment. If all faces in the region of interest have been matched, then block 712 may allow access.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for managing access, comprising:
detecting a person within a region of interest in a video stream;
determining that a clear image of the person's face is not available within the region of interest;
matching tracking information of the person to historical face tracking information for the person in a previously captured frame;
matching the person's face from the previously captured video frame to an authentication list, responsive to detecting the person within the region of interest, to determine that the detected person is unauthorized for access; and
responding to the determination that the detected person is unauthorized for access.

2. The computer-implemented method of claim 1, further comprising:
tracking the person in the video stream to generate historical person detection tracking information; and
tracking the person's face in the video stream to generate the historical face tracking information.

3. The computer-implemented method of claim 2, wherein matching tracking information of the person to historical tracking information for the person's face includes identifying a match between the historical person detection tracking information and the historical face tracking information.

4. The computer-implemented method of claim 3, wherein identifying the match between the historical person detection tracking information and the historical face tracking information includes identifying a bounding box for person detection for frames in the video stream and identifying a bounding box for face detection for frames in the video stream.

5. The computer-implemented method of claim 4, wherein identifying the match between the historical person detection tracking information and the historical face tracking information includes identifying an overlap between the bounding box for person detection and the bounding box for face detection in at least one frame of the video stream.

6. The computer-implemented method of claim 1, wherein responding to the determination that the detected person is unauthorized for access includes waiting a predetermined time, while additional video is captured.

7. The computer-implemented method of claim 6, wherein responding to the determination that the detected person is unauthorized for access is canceled responsive to a determination that the person is authorized, based on facial recognition from the additional video.

8. The computer-implemented method of claim 1, wherein matching the person's face from the previously captured video frame to an authentication list to determine that the detected person is unauthorized for access includes determining that no suitable face image is available in the historical face tracking information.

9. The computer-implemented method of claim 1, wherein matching the person's face from the previously captured video frame to an authentication list to determine that the detected person is unauthorized for access includes determining that the person's face does not match any authorized person in the authentication list.

10. The computer-implemented method of claim 1, wherein responding to the determination that the detected person is unauthorized for access includes triggering an alarm.

11. A system for managing access, comprising:
a hardware processor; and
a memory that stores a computer program product, which, when executed by the hardware processor, causes the hardware processor to:
detect a person within a region of interest in a video stream;
determine that a clear image of the person's face is not available within the region of interest;
match tracking information of the person to historical face tracking information for the person in a previously captured frame;
match the person's face from the previously captured video frame to an authentication list, responsive to detecting the person within the region of interest, to determine that the detected person is unauthorized for access; and
respond to the determination that the detected person is unauthorized for access.

12. The computer-implemented method of claim 11, wherein the computer program product further causes the hardware processor to:
tracking the person in the video stream to generate historical person detection tracking information; and
tracking the person's face in the video stream to generate the historical face tracking information.

13. The computer-implemented method of claim 12, wherein the computer program product further causes the hardware processor to identify a match between the historical person detection tracking information and the historical face tracking information.

14. The computer-implemented method of claim 13, wherein the computer program product further causes the hardware processor to identify a bounding box for person detection for frames in the video stream and to identify a bounding box for face detection for frames in the video stream.

15. The computer-implemented method of claim 14, wherein the computer program product further causes the hardware processor to identify an overlap between the bounding box for person detection and the bounding box for face detection in at least one frame of the video stream.

16. The computer-implemented method of claim 11, wherein the computer program product further causes the hardware processor to wait a predetermined time, while additional video is captured, before responding to the determination that the detecting person is unauthorized for access.

17. The computer-implemented method of claim 16, wherein the computer program product further causes the hardware processor to cancel the response to the determination that the detected person is unauthorized for access responsive to a determination that the person is authorized, based on facial recognition from the additional video.

18. The computer-implemented method of claim 11, wherein the computer program product further causes the hardware processor to determine that no suitable face image is available in the historical face tracking information.

19. The computer-implemented method of claim 11, wherein the computer program product further causes the hardware processor to determine that the person's face does not match any authorized person in the authentication list.

20. The computer-implemented method of claim 11, wherein the computer program product further causes the hardware processor to trigger an alarm to respond to the determination that the detected person is unauthorized for access.
